(19) United States
(12) Patent Application Publication
(10) Pub. No.: US 2026/0163738 A1
(43) Pub. Date: Jun. 11, 2026

(54) FULL REMOTE ATTESTATION WITHOUT HARDWARE SECURITY ASSURANCES

(71) Applicant: Google LLC, Mountain View, CA (US)

(72) Inventors: Christopher Ian Schneider, London (GB); J. Nicolas Watson, Reston, VA (US); René Mayrhofer, Wien (AT)

(21) Appl. No.: 19/104,045

(22) PCT Filed: Jul. 18, 2023
(86) PCT No.: PCT/US2023/028028

§ 371 Date: Feb. 14, 2025

Related U.S. Application Data
(60) Provisional application No. 63/373,521, filed on Aug. 25, 2022.

(51) Int. Cl. H04L 9/32; H04L 9/08

(52) U.S. Cl. CPC H04L 9/3221; H04L 9/0861

(57) ABSTRACT

A computing device may generate a zero-knowledge proof that the computing device has one or more properties and may send an indication of the zero-knowledge proof to a. computing system. The computing system may verify that the zero-knowledge proof proves the computing device has the one or more properties and may, in response to successfully verifying that the zero-knowledge proof proves the computing device has the one or more properties, grant the computing device permission to perform an action that requires the computing device to have the one or more properties.

This application claims the benefit of U.S. Provisional Patent Application No. 63/373,521, filed 25 Aug. 2022, the entire content of which is incorporated herein by reference.

### BACKGROUND

Remote attestation is a mechanism for authenticating and verifying the integrity of a computing device to determine whether the platform is trusted. In some examples, a computing system may perform remote attestation of a computing device via the use of hardware security assurances to determine whether the computing device has been modified or otherwise compromised. Such hardware security assurances may be provided using specialized hardware and/or firmware, such as a trusted platform module (TPM) chip or other physical security mechanisms, in the computing device that can prove the integrity of the computing device to the computing system.

### SUMMARY

In general, the techniques of this disclosure are directed to performing full remote attestation of a computing device that does not use specialized hardware and/or firmware, such as a trusted platform module (TPM) chip or other physical security mechanisms, to prove the integrity of the computing device. Instead, the computing device may provide a zero-knowledge proof (ZKP), such as a zero-knowledge succinct non-interactive argument of knowledge (zk-SNARK) proof, that the computing device is in a specific configuration, thereby proving the integrity of the computing device without the use of specialized hardware and/or firmware and without leaking the details of the specific configuration of the computing device.

In some aspects, the techniques described herein relate to a method including: receiving, by one or more processors of a computing system and from a computing device, an indication of a zero-knowledge proof that the computing device has one or more properties; verifying, by the one or more processors, that the zero-knowledge proof proves the computing device has the one or more properties; and in response to successfully verifying the zero-knowledge proof, granting, by the one or more processors, the computing device permission to perform an action that requires the computing device to have the one or more properties.

In some aspects, the techniques described herein relate to a computing system including: a memory that stores instructions; and one or more processors that execute the instructions to: receive, from a computing device, an indication of a zero-knowledge proof that the computing device has one or more properties; verify that the zero-knowledge proof proves the computing device has the one or more properties; and in response to successfully verifying the zero-knowledge proof, grant the computing device permission to perform an action that requires the computing device to have the one or more properties.

In some aspects, the techniques described herein relate to an apparatus including: means for receiving, from a computing device, an indication of a zero-knowledge proof that the computing device has one or more properties; verifying that the zero-knowledge proof proves the computing device has the one or more properties; and means for, in response to successfully verifying the zero-knowledge proof, granting the computing device permission to perform an action that requires the computing device to have the one or more properties.

In some aspects, the techniques described herein relate to a non-transitory computer-readable storage medium including instructions, that when executed by one or more processors of a computing system, cause the one or more processors to: receive, from a computing device, an indication of a zero-knowledge proof that the computing device has one or more properties; verify that the zero-knowledge proof proves the computing device has the one or more properties; and in response to successfully verifying the zero-knowledge proof, grant the computing device permission to perform an action that requires the computing device to have the one or more properties.

In some aspects, the techniques described herein relate to a method including: generating, by one or more processors of a computing device, a zero-knowledge proof that the computing device has one or more properties; sending, by the one or more processors to a computing system, an indication of the zero-knowledge proof, and in response to the computing system successfully verifying the zero-knowledge proof, receiving, by the one or more processors, data that enables the computing device to perform an action that requires the computing device to have the one or more properties.

In some aspects, the techniques described herein relate to a computing device including: a memory that stores instructions; and one or more processors that execute the instructions to: generate a zero-knowledge proof that the computing device has one or more properties; send, to a computing system, an indication of the zero-knowledge proof, and in response to the computing system successfully verifying the zero-knowledge proof, receive data that enables the computing device to perform an action that requires the computing device to have the one or more properties, receive, from a computing device, an indication of a zero-knowledge proof that the computing device has one or more properties; verify that the zero-knowledge proof proves the computing device has the one or more properties; and in response to successfully verifying the zero-knowledge proof, grant the computing device permission to perform an action that requires the computing device to have the one or more properties.

In some aspects, the techniques described herein relate to an apparatus including: means for generating a zero-knowledge proof that the computing device has one or more properties; means for sending, to a computing system, an indication of the zero-knowledge proof; and means for, in response to the computing system successfully verifying the zero-knowledge proof, receiving data that enables the computing device to perform an action that requires the computing device to have the one or more properties

[symbol]

In some aspects, the techniques described herein relate to a non-transitory computer-readable storage medium including instructions, that when executed by one or more processors of a computing device, cause the one or more processors to: generate a zero-knowledge proof that the computing device has one or more properties; send, to a computing system, an indication of the zero-knowledge proof; and in response to the computing system successfully verifying the zero-knowledge proof, receive data that enables the computing device to perform an action that requires the computing device to have the one or more properties.

The details of one or more examples are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a conceptual diagram illustrating an example environment for remote attestation, in accordance with one or more aspects of the present disclosure.

FIG. 2 is a block diagram illustrating further details of an example computing device, in accordance with one or more aspects of the present disclosure.

FIG. 3 is a block diagram illustrating further details of an example computing system, in accordance with one or more aspects of the present disclosure.

FIG. 4 illustrates an example technique for remote attestation, in accordance with aspects of this disclosure.

FIG. 5 is a flow chart of an example process for an example computing device to attest to having one or more properties, in accordance with aspects of this disclosure.

FIG. 6 is a flow chart of an example process for an example computing system to perform remote attestation of an example computing device, in accordance with aspects of this disclosure.

FIG. 7 is a flow chart of an example process for remote attestation, in accordance with aspects of this disclosure.

FIG. 8 is a flow chart of an example process for remote attestation, in accordance with aspects of this disclosure.

### DETAILED DESCRIPTION

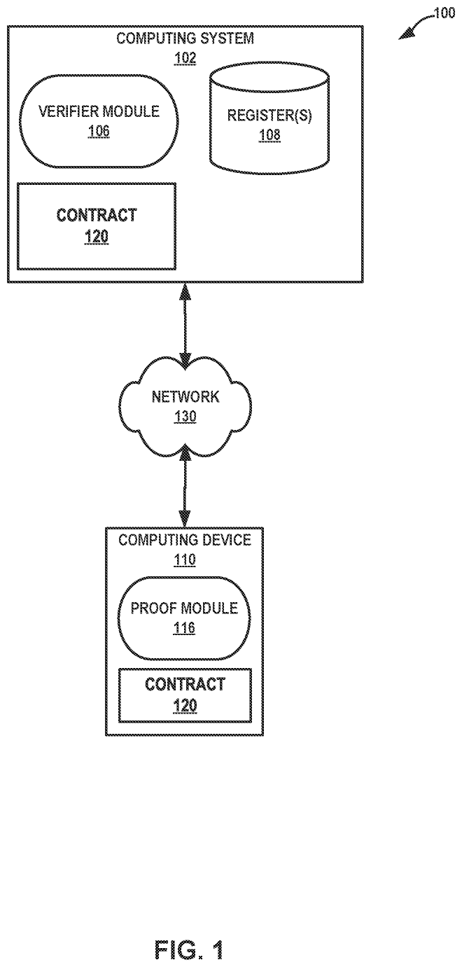

FIG. 1 is a conceptual diagram illustrating an example environment for remote attestation, in accordance with one or more aspects of the present disclosure. In the example of FIG. 1, environment 100 may include computing system 102 that communicates with computing device 110 via network 130.

Computing system 102 may represent any suitable computing system, such as one or more desktop computers, laptop computers, mainframes, servers, cloud computing systems, etc. capable of sending and receiving information both to and from a network, such as network 130. In some examples, the components of computing system 102 illustrated in FIG. 1 may reside and execute on the same or separate computing devices and systems operated by and/or under the control of one or more entities. In some examples, computing system 102 may represent one or more cloud computing systems that provide access to their respective services via a cloud.

Computing system 102 may include verifier module 106 and one or more registers 108. Verifier module 106 may perform operations described herein using software, hardware, firmware, or a mixture of hardware, software, and firmware residing in and/or executing at computing system 102 to perform functions associated with performing remote attestation of computing device 110 and verifying mathematical proofs. Computing system 102 may execute verifier module 106 with multiple processors or multiple devices, as virtual machines executing on underlying hardware, as one or more services of an operating system or computing platform, and/or as one or more executable programs at an application layer of a computing platform of computing system 102. One or more registers 108 may be any suitable data store, such as a database, a repository, a blockchain, a journal, a certificate authority, and the like for storing data associated with performing remote attestation of computing device 110.

Network 130 represents any public or private communications network, for instance, cellular, Wi-Fi, and/or other types of networks, for transmitting data between computing systems, servers, and computing devices. Network 130 may include one or more network hubs, network switches, network routers, or any other network equipment, that are operatively inter-coupled thereby providing for the exchange of information between computing system 102 and computing device 110. Computing device 110 and computing system 102 may transmit and receive data across network 130 using any suitable communication techniques. Each of computing system 102 and computing device 110 be operatively coupled to network 130 using respective network links, such as Ethernet, Wi-Fi, or any other types of wired and/or wireless network connections.

Computing device 110 represents an individual mobile or non-mobile computing device. Examples of computing device 110 include a mobile phone, a tablet computer, a laptop computer, a desktop computer, a server, a mainframe, a set-top box, a television, a wearable device (e.g., a computerized watch, computerized eyewear, computerized headphones, computerized gloves, etc.), a home automation device or system (e.g., an intelligent thermostat or home assistant device), a personal digital assistant (PDA), a gaming system, a media player, an e-book reader, a mobile television platform, an automobile navigation or infotainment system, or any other type of mobile, non-mobile, wearable, and non-wearable computing device. Computing device 110 may not include and/or use specialized hardware and/or firmware, such as a trusted platform module (TPM) chip or other physical security mechanisms, for proving the integrity of computing device 110 or for providing any hardware security assurances.

Computing device 110 may include proof module 116. Proof module 116 may perform operations described herein using software, hardware, firmware, or a mixture of hardware, software, and firmware residing in and/or executing at computing device 110 to perform functions associated with generating mathematical proofs that computing device 110 has one or more properties. Computing device 110 may execute proof module 116 with multiple processors or multiple devices, as virtual machines executing on underlying hardware, as one or more services of an operating system or computing platform, and/or as one or more executable programs at an application layer of a computing platform of computing device 110.

Computing device 110 may be permitted to perform certain actions only if computing system 102 can verify that computing device 110 has certain properties, such as having a certain configuration of data, software, hardware, and/or combinations thereof. As such, computing system 102 may perform remote attestation of computing device 110 to determine whether computing device 110 has one or more properties that are required in order for computing device 110 is permitted to perform an action, and computing system 102 may permit computing device 110 to perform the action only if computing system 102 can verify that computing device 110 has the one or more required properties. Examples of the specific properties of computing device 110 include the whether the version of firmware installed at computing device 110 is within a specified range of versions, whether the firmware installed at computing device 110 at the factory or via a software update has been modified and/or tampered, whether computing device 110 has been modified, whether computing device 110 is in a valid configuration, whether specific peripherals are connected and/or not connected to computing device 110, whether the manufacturing date of computing device 110 is within a specified range of dates, and/or any combination thereof.

For example, in order for computing device 110 to play a video stream encrypted using Digital Rights Management (DRM), a policy associated with the DRM may require confirmation that the display pipeline of the hardware of computing device 110 has not been tampered with prior to initiating the stream. As such, computing system 102 may perform remote attestation of computing device 110 to determine whether computing device 110 has the property that its display pipeline has not been tampered with. In another example, in order for computing device 110 to execute a particular video game application, the video game may have a policy that no external human interface device (HID) is connected to computing device 110. As such, computing system 102 may perform remote attestation of computing device 110 to determine that no external HID is connected to computing device 110.

Computing system 102 may be able to perform full remote attestation of computing device 110 without computing device 110 having and/or using specialized hardware and/or firmware, such as a trusted platform module (TPM) chip or other physical security mechanisms, to prove the integrity of computing device 110. While specialized hardware and/or firmware may provide hardware security assurances that a computing device has not been modified or otherwise compromised, including such specialized hardware in computing devices may increase the manufacturing costs of these computing devices. Further, if the specialized hardware of a computing device is ever compromised, the computing device may permanently be prevented from providing hardware security assurances, which may prevent the computing device from performing certain functions that require such hardware security assurances.

Instead, in order for computing system 102 to verify that computing device 110 has one or more properties that are required in order for computing device 110 to perform a particular action, computing device 110 may generate a mathematical proof that computing device 110 has the one or more properties (e.g., is in a particular configuration), and may send the proof to computing system 102. In response to receiving the mathematical proof, computing system 102 may verify the mathematical proof that computing device 110 has the one or more properties. If computing system 102 verifies that the mathematical proof provided by computing device 110 proves that computing device 110 has the one or more properties, computing system 102 may grant computing device 110 permission to perform the particular action.

Computing device 110 may generate a mathematical proof that computing device 110 has the one or more properties in the form of a zero-knowledge proof, which is a cryptographic technique in which a prover (e.g., computing device 110) can prove to a verifier (e.g., computing system 102) that the prover possesses knowledge of a secret parameter, referred to as a witness, satisfying some relation, without revealing the witness or any additional information to the verifier or anyone else. In the example of proving that computing device 110 is in a particular configuration, a zero-knowledge proof may prove that computing device 110 is in a particular configuration without revealing the configuration of computing device 110 or any other information regarding computing device 110. That is, a zero-knowledge proof that proves computing device 110 has one or more properties may not reveal any additional information regarding what other properties computing device 110 may or may not have.

One example of a zero-knowledge proof is a zero-knowledge succinct non-interactive argument of knowledge (zk-SNARK) proof. A zk-SNARK proof is succinct by being very small in size, such that verification of a zk-SNARK proof can be performed relatively quickly. A zk-SNARK proof is also non-interactive, such that only one set of information may be sent to the verifier for verification without any interaction from the verifier (i.e., without sending messages back and forth to and from the verifier), thereby decreasing the amount of network traffic communicated between computing device 110 and the verifier (e.g., computing system 102). A zk-SNARK proof may also assure semantic security against a prover within polynomial time constraints. An encryption scheme that encrypts the plaintext is provable to be semantically secure if an adversary that receives either one of two plaintexts, m₀ and m₁, cannot guess with better probability than ½ whether a given ciphertext is an encryption of the plaintext m₀ or an encryption of plaintext m₁. A zk-SNARK proof therefore assures semantic security such that an adversary cannot feasibly extract information from a zk-SNARK proof besides proof that computing device 110 has the one or more properties. A zk-SNARK proof cannot be constructed without access to the witness, so that the witness is verified as being present at the time the proof is generated. Computing device 110 may construct a zk-SNARK proof using an identity, which may be a unique piece of information bound to computing device 110, such as a password or other information that is known only to computing device 110 and a witness, which is a secret parameter, such that the zk-SNARK proof mathematically proves computing device 110 has knowledge of the witness.

In the example of proving that computing device 110 has one or more properties that are required to perform an action, the witness may be a secret parameter, such as in the form of a hash, an alphanumeric string, or any other piece of data, that indicates computing device 110 has the one or more properties required to perform the action, and proof module 116 of computing device 110 may generate a zk-SNARK proof that mathematically proves computing device 110 is in possession of the witness without indicating, in the zk-SNARK proof, the witness itself. Computing system 102 may also be in possession of the witness. As such, verifier module 106 of computing system 102 may verify a zk-SNARK proof by determining whether the zk-SNARK proof actually proves that computing device 110 is in possession of the witness.

Using zero-knowledge proofs to prove that computing device 110 is in a particular configuration may enable computing system 102 to perform remote attestation of computing device 110 without hardware security assurances, thereby enabling computing system 102 to perform remote attestation of computing device 110 that does not include or use specialized hardware and/or firmware to provide such hardware security assurances. By using zero-knowledge proofs to perform remote attestation of computing device 110, the techniques of this disclosure may improve the reliability and security of computing device 110 by enabling computing device 110 to not depend on using specialized hardware and/or firmware which may fail and/or may be compromised to provide such hardware security assurances.

Furthermore, because zk-SNARK proofs are both highly succinct and non-interactive, using a zk-SNARK proof to prove that computing device 110 is in a particular configuration may enable computing device 110 to reduce the amount of data that is transmitted to computing system 102 via network 130 to prove that computing device 110 is in a particular configuration, compared with other techniques for proving that computing device 110 is in a particular configuration. As such, the techniques of this disclosure may reduce the bandwidth utilization of network 130 by computing device 110 to prove that computing device 110 is in a particular configuration.

In addition, zk-SNARK proofs may be highly computationally efficient compared with other techniques for proving that computing device 110 is in a particular configuration. The computational efficiency of zk-SNARK proof may reduce the processing overhead of computing device 110 to generate a zk-SNARK proof to prove that computing device 110 is in a particular configuration and the processing overhead of computing system 102 to determine whether a zk-SNARK proof proves that computing device 110 is in a particular configuration.

In addition, because zero-knowledge proofs may prove that computing device 110 is in a particular configuration without revealing the configuration of computing device 110 or any other information regarding computing device 110, using zero-knowledge proofs to prove that computing device 110 is in a particular configuration may minimize the amount of information regarding computing device 110 that is leaked or transmitted to other parties. As such, the techniques of this disclosure may be able to preserve the privacy and confidentiality of the computing device 110.

In one illustrative example, computing system 102 may determine that, when computing device 110 is in a particular configuration, the cryptographic sum of certain applications executing at computing device 110 is a certain value (e.g., 47). The cryptographic sum of the certain applications executing at the computing device may be the witness, and computing device 110 may generate a zk-SNARK proof that mathematically proves that computing device 110 is in possession of the value (e.g., 47) of the cryptographic sum of the certain applications executing at computing device 110 without revealing the actual value of the cryptographic sum. Computing system 102 may verify the zk-SNARK proof to determine whether the proof successfully proves that the cryptographic sum of applications executing at computing device 110 as possessed by computing device 110 matches the cryptographic sum determined by computing system 102, upon successful verification of the proof, determine that the computing device is in the particular configuration.

In some examples, computing system 102 may not make a binary determination as to whether the zk-SNARK proof actually proves that computing device 110 is in possession of the witness. Instead, computing system 102 may determine a probability that the zk-SNARK proof actually proves that computing device 110 is in possession of the witness, and computing system 102 may compare the determined probability with a probability threshold to determine whether the zk-SNARK proof is successfully verified as proving that computing device 110 is in possession of the witness. That is, if computing system 102 determines that the probability that the zk-SNARK proof actually proves that computing device 110 is in possession of the witness is higher than a probability threshold, computing system 102 may determine that the zk-SNARK proof is successfully verified as proving that computing device 110 is in possession of the witness.

A probability threshold may be adjustable based on, for example, the risk appetite of computing device 110, as a lower probability threshold may increase false positives (i.e., successfully verifying zk-SNARK proofs that do not actually prove that computing device 110 is in possession of the witness), while a higher probability threshold may increase false negatives (i.e., unsuccessfully verifying zk-SNARK proofs that do actually prove that computing device 110 is in possession of the witness). Examples of probability thresholds include 95%, 99%, and the like.

If computing system 102 is able to successfully verify the proof that computing device 110 has the one or more properties, computing system 102 may grant computing device 110 permission to perform the particular action. Granting computing device 110 permission to perform a certain action may include granting computing device 110 access to certain resources, such as access to cryptographic keys (e.g., encryption keys) that authorize computing device 110 to perform one or more actions. For example, if computing system 102 is able to successfully verify a proof that computing device 110's display pipeline has not been tampered with, computing system 102 may grant computing device 110 access to a cryptographic key to decrypt an encrypted video, thereby enabling computing device 110 to decrypt and playback the encrypted video.

One or more registers 108 of computing system 102 may act as a trusted journal of events for recording information associated with the verification of one or more properties of computing system 102. Computing system 102 or any other entities may not be able to delete any information from one or more registers 108. Instead, computing system 102 may only be able to add information to one or more registers 108. In this way, one or more registers 108 may act as a trusted journal of information regarding whether computing device 110 has been successfully verified as having one or more properties, for the purposes of granting computing device 110 permission to perform certain actions.

In some examples, each time computing system 102 verifies a proof that computing device 110 has one or more properties, computing system 102 may add an entry to one or more registers 108 that includes information associated with the verification of the proof, such as whether computing system 102 was able to successfully verify the proof, the one or more properties being proved, the action that requires computing device 110 to have the one or more properties, and the like. As such, one or more registers 108 may provide information regarding whether computing device 110 is currently successfully verified as having one or more properties, for the purposes of granting computing device 110 permission to perform certain actions.

For example, an entity that stores an encryption key for decrypting an encrypted video for playback may determine, based on the information stored in one or more registers 108, whether computing system 102 has verified computing device 110 as having one or more properties (e.g., a secure video playback data path) that are required to playback the encrypted video. If the information stored in one or more registers 108 indicate that computing system 102 has verified computing device 110 as having the one or more properties that are required to playback the encrypted video, the entity may grant permission to computing device 110 to playback the encrypted video, such as by sending an encryption key for decrypting the encrypted video to computing device 110.

Contract 120 associated with computing device 110 may govern actions that computing device 110 is allowed to perform based on the state of computing device 110. For example, contract 120 may be a cryptographic contract, such as a smart contract, that associates each of one or more actions with a particular one or more properties of computing device 110, such that computing device 110 may allow computing device 110 to perform an action only if it can be verified that computing device 110 has the one or more properties associated with the action as specified by contract 120.

One or more entities may determine the actions that computing device 110 is allowed to perform based at least in part on verifying the state of computing device 110, and computing device 110 may generate contract 120 based on parameters determined by the one or more entities. Such parameters may indicate one or more actions and, for each of the one or more actions, an associated one or more properties of computing device 110 that, if verified, allows computing device 110 to perform the action. The one or more entities may be trusted parties such as the manufacturer of computing device 110, the provider of the operating system for computing device 110, and/or other parties that may be trusted to determine the actions that computing device 110 is allowed to perform based at least in part on verifying the state of computing device 110. In this way, multiple entities or parties may be able to collectively create contracts split between the multiple entities for access to one or more services and/or actions by computing device 110.

Computing device 110 may generate contract 120 by generating cryptographic key material based on the parameters determined by the one or more entities and by generating contract 120 using the cryptographic key material. Cryptographic key material, in some examples, may be the actual bytes or numbers in a cryptographic key that are used in cryptographic computations, such as the bytes and numbers of a cryptographic key used to generate contract 120 and/or to otherwise secure the transactions and data involved in contract 120. Contract 120 acts as a signature for one or more attestable states of computing device 110, such as the state of computing device 110's firmware, and is bound to unique information on computing device 110, which is referred to herein as an identity. The identity associated with computing device 110 is bound to computing device 110 by a witness. In the example where computing device 110 generates contract 120, the witness may be a form of authentication, such as a password entered by a user.

Computing device 110 may generate contract 120 when a valid contract does not exist. This may mean that computing device 110 may generate contract 120 if computing device 110 has not previously generated a contract or if a previously-generated contract has been invalidated. A previously-generated contract may have been invalidated if computing device 110 was not able to prove that computing device 110 has the one or more properties specified by the previously-generated contract. For example, if the previously-generated contract specifies that computing device 110's firmware has not been compromised, and if computing device 110's firmware was subsequently compromised after the previously-generated contract was generated, computing system 102 may invalidate the previously-generated contract.

Enabling computing device 110 to generate contract 120 even after the previously-generated contract was invalidated may enable computing device 110 to have additional flexibility to be modified without preventing computing device 110 from being able to perform actions that require remote attestation of the properties of computing device 110. For example, the user of computing device 110 may root computing device 110's firmware, which may cause computing system 102 to invalidate a contract that specifies computing device 110's firmware has not been modified. Subsequently, the user may be able to re-install a non-modified version of computing device 110's firmware, and computing device 110 may be able to generate a valid contract that specifies computing device 110's firmware has not been modified.

Computing device 110 may, in response to generating contract 120, send contract 120 to computing system 102. In some examples, computing device 110 may cryptographically sign contract 120 using information already known by computing system 102 and computing device 110 but not known to other parties, and may send the signed contract 120 to computing system 102.

Computing system 102 may, in response to receiving contract 120, verify contract 120, such as by determining whether contract 120 is signed using valid information known to computing system 102. Computing system 102 may, in response to successfully verifying contract 120, generate an attestation proof of computing device 110 and add the attestation proof to one or more registers 108. That is, computing device 110 may add an entry to one or more register 108 indicating that computing device 110 has the one or more properties specified by contract 120 and/or that contract 120 is a valid contract between computing device 110 and computing system 102.

Computing device 110 may, subsequent to generating and sending contract 120 to computing system 102, sign contract 120 by formulating a zero-knowledge proof that computing device 110 has one or more properties and sending the zero-knowledge proof to computing system 102. That is, once computing device 110 has generated contract 120 that specifies computing device 110 as having one or more properties, computing device 110 may send a zero-knowledge proof that computing device 110 has the one or more properties by signing contract 120 with the zero-knowledge proof that computing device 110 has the one or more properties.

Computing system 102 may, in response to receiving the zero-knowledge proof that computing device 110 is in the particular state and sending the zero-knowledge proof to computing system 102, attempt to verify the zero-knowledge proof. That is, computing system 102 may determine whether the zero-knowledge proof successfully proves that computing device 110 has the one or more properties specified by contract 120 to perform an associated action.

If computing system 102 determines that the zero-knowledge proof does not prove that computing device 110 has the one or more properties specified by contract 120 to perform an associated action, computing system 102 may invalidate contract 120. If computing system 102 determines that the zero-knowledge proof proves that computing device 110 has the one or more properties specified by contract 120 to perform an associated action, computing system 102 may permit computing device 110 to perform the action associated with the one or more properties of computing device 110 as specified by contract 120, such as by granting computing device 110 access to a resource used by computing device 110 to perform the action associated with the one or more properties of computing device 110. For example, computing system 102 may grant computing device 110 access to an encryption key, used by computing device 110 to decrypt an encrypted video by sending the encryption key to computing device 110. In this way, computing system 102 may use the successful verification of the zero-knowledge proof to temporarily control access and authorization of assets and resources to computing device 110.

If computing system 102 determines that the zero-knowledge proof proves that computing device 110 has the one or more properties specified by contract 120 to perform an associated action, computing system 102 may perform ratcheting, such as via use of a double ratchet algorithm, of a cryptographic key used to securely communicate with computing device 110. For example, because computing device 110 sends an indication of the zero-knowledge proof to computing system 102 by signing contract 120, contract 120 may act as a cryptographic key for communications between computing device 110 and computing system 102. As such, each time computing system 102 successfully verifies a zero-knowledge proof that computing device 110 has the one or more properties specified by contract 120, computing device 110 may perform ratcheting of contract 120, so that even if contract 120 is compromised (e.g., stolen off of computing device 110), the ratcheting of contract 120 may prevent malicious actors from using the stolen cryptographic key to compromise communications between computing system 102 and computing device 110.

After computing device 110 has generated contract 120 and after computing device 110 has successfully verified that the zero-knowledge proof proves that computing device 110 has the one or more properties specified by contract 120 to perform an associated action, computing system 102 may continue to perform remote attestation of computing device 110. That is, computing device 110 may continue to generate and send, to computing system 102, zero-knowledge proofs that computing device 110 has the one or more properties specified by contract 120, and computing system 102 may attempt to verify the zero-knowledge proofs that computing device 110 has the one or more properties specified by contract 120.

For example, if a software application executing at computing device 110 performs an action that requires computing device 110 to prove that computing device 110 has the one or more properties specified by contract 120, computing device 110 may perform remote attestation that computing device 110 has the one or more properties specified by contract 120 each time the software application is launched and/or may periodically perform such remote attestation while the software application executes. In this way, computing system 102 may be able to ensure that contract 120 remains valid in order to continue to grant the software application permission to perform the action.

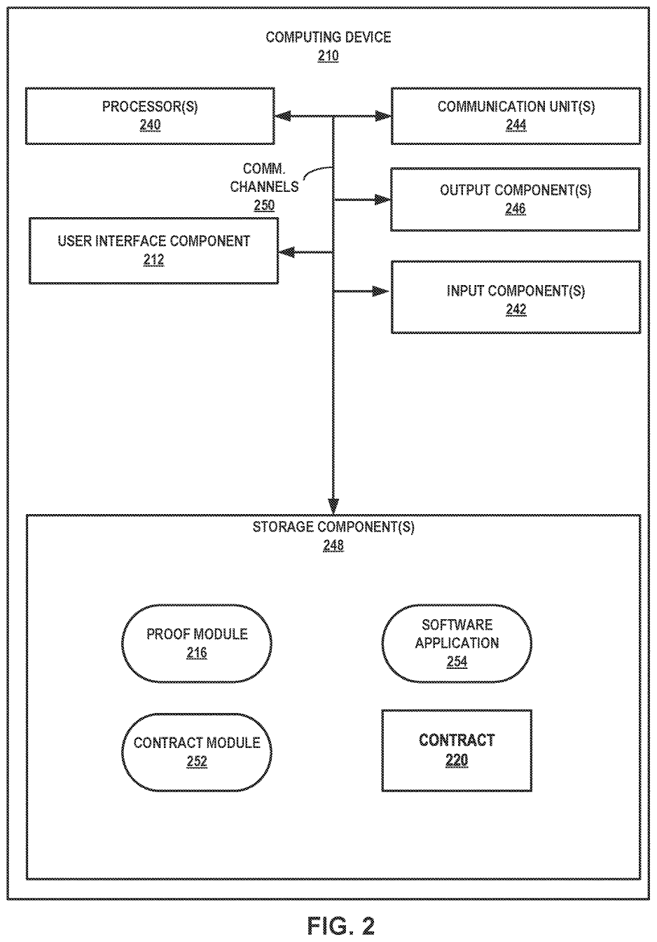

FIG. 2 is a block diagram illustrating further details of an example computing device, in accordance with one or more aspects of the present disclosure. Computing device 210 of FIG. 2 is described below as an example of computing device 110 as illustrated in FIG. 1

Computing device 210 of FIG. 2 may be an example of a mobile phone, a tablet computer, a laptop computer, a desktop computer, a server, a mainframe, a set-top box, a television, a wearable device, a home automation device or system, a gaming system, a media player, an e-book reader, a mobile television platform, an automobile navigation or infotainment system, or any other type of mobile, non-mobile, wearable, and non-wearable computing device configured to receive, and output an indication of notification data. FIG. 2 illustrates only one particular example of computing device 210, and many other examples of computing device 210 may be used in other instances and may include a subset of the components included in example computing device 210 or may include additional components not shown in FIG. 2.

As shown in the example of FIG. 2, computing device 210 includes UIC 212, one or more processors 240, one or more input components 242, one or more communication units 244, one or more output components 246, and one or more storage components 248. One or more storage components 248 of computing device 210 also include proof module 216, contract module 252, software application 254, and contract 220. Proof module 216 may be an example of proof module 116 shown in FIG. 1 and contract 120 may be an example of contract 120 shown in FIG. 1.

Communication channels 250 may interconnect each of the components 240, 212, 244, 246, 242, and 248 for inter-component communications (physically, communicatively, and/or operatively). In some examples, communication channels 250 may include a system bus, a network connection, an inter-process communication data structure, or any other method for communicating data.

One or more input components 242 of computing device 210 may receive input. Examples of input are tactile, audio, and video input. Input components 242 of computing device 210, in one example, includes a presence-sensitive display, touch-sensitive screen, mouse, keyboard, voice responsive system, video camera, microphone or any other type of device for detecting input from a human or machine.

One or more output components 246 of computing device 210 may generate output. Examples of output are tactile, audio, and video output. Output components 246 of computing device 210, in one example, includes a presence-sensitive display, sound card, video graphics adapter card, speaker, liquid crystal display (LCD), organic light-emitting diode (OLED) display, a light field display, haptic motors, linear actuating devices, or any other type of device for generating output to a human or machine.

One or more communication units 244 of computing device 210 may communicate with external devices via one or more wired and/or wireless networks by transmitting and/or receiving network signals on the one or more networks. Examples of one or more communication units 244 include a network interface card (e.g., an Ethernet card), an optical transceiver, a radio frequency transceiver, a GPS receiver, or any other type of device that can send and/or receive information. Other examples of one or more communication units 244 may include short wave radios, cellular data radios, wireless network radios, as well as universal serial bus (USB) controllers.

UIC 212 of computing device 210 may be hardware that functions as an input and/or output device for computing device 210. For example, UIC 212 may include a display component, which may be a screen at which information is displayed by UIC 212 and a presence-sensitive input component that may detect an object at and/or near the display component.

One or more processors 240 may implement functionality and/or execute instructions within computing device 210. For example, one or more processors 240 on computing device 210 may receive and execute instructions stored by one or more storage components 248 that execute the functionality of proof module 216, contract module 252, and software application 254. The instructions executed by one or more processors 240 may cause computing device 210 to store information within one or more storage components 248 during program execution. Examples of one or more processors 240 include application processors, display controllers, sensor hubs, and any other hardware configured to function as a processing unit. One or more processors 240 may execute instructions of proof module 216, contract module 252, and software application 254 to perform actions or functions. That is, proof module 216, contract module 252, and software application 254 may be operable by one or more processors 240 to perform various actions or functions of computing device 210.

One or more storage components 248 within computing device 210 may store information for processing during operation of computing device 210. That is, computing device 210 may store data accessed by proof module 216, contract module 252, and software application 254 during execution at computing device 210. In some examples, one or more storage component 248 is a temporary memory, meaning that a primary purpose of one or more storage component 248 is not long-term storage. One or more storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

One or more storage components 248, in some examples, also include one or more computer-readable storage media. One or more storage components 248 may be configured to store larger amounts of information than volatile memory. One or more storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. One or more storage components 248 may store program instructions and/or information (e.g., data) associated with proof module 216, contract module 252, software application 254, and contract 220. Proof module 216 may execute at one or more processors 240 to perform functions similar to that of proof module 116 of FIG. 1.

Software application 254 may represent any suitable software application executing on executing at computing device 210. A user of computing device 210 may interact with an interface (e.g., a graphical user interface) associated with software application 254 to cause computing device 210 to perform a function. Numerous examples of software application 254 may exist and include, a video streaming application, a calendar application, a personal assistant or prediction engine, a search application, a map or navigation application, a transportation service application (e.g., a bus or train tracking application), a social media application, a game application, an e-mail application, a messaging application, an Internet browser application, or any and all other applications that may execute at computing device 210.

Software application 254 may, in some instances, not be permitted to perform an action if computing device 210 does not have certain properties. For example, if software application 254 is an online banking application, software application 254 may not be able to receive, from an online banking website, a security token to securely perform online banking activities with the banking website if the version of computing device 210's firmware is outside an acceptable range of firmware versions. As such, in order to perform certain actions, software application 254 may attempt to prove that computing device 210 has one or more properties that may be required for computing device 210 to perform those certain actions.

Contract module 252 may be configured to generate contracts that specify actions and, for each action, one or more properties computing device 210 may be required to have in order to perform the action. For example, contract module 252 may execute at one or more processors 240 to generate contract 220, which is an example of contract 120 shown in FIG. 1, associated with software application 254 that specifies, for software application 254, an action and an associated one or more specified properties that computing device 210 is required to have in order to perform the action.

Contract module 252 may be configured to generate contract 220 associated with software application 254 prior to software application 254 performing the action specified in contract 220. In some examples, contract module 252 may be configured to generate contract 220 upon installation of software application 254 at computing device 210, upon software application 254 being launched for the first time, upon each time software application 254 is updated, or at any other suitable time.

Contract module 252 may be configured to receive, from a computing system (e.g., computing system 102 shown in FIG. 1), one or more parameters associated with contract 220. The one or more parameters may, in some examples, indicate an action associated with one or more properties, and contract module 252 may be configured to generate, based on the one or more parameters, contract 220 that associates the indicated action with the indicated one or more properties. For example, contract module 252 may be configured to generate cryptographic key material based on the one or more parameters, and may use the cryptographic key material to generate contract 220.

Contract module 252 may be configured to generate contract 220 in the form of a cryptographic key that may be used to authenticate computing device 210 and/or software application 254 as an entity to which permission can be granted to perform the action specified in contract 220. In some examples, contract module 252 may further be configured to generate contract 220 using secret authentication information, such as a password entered by a user (e.g., at one or more input components 242) or other suitable authentication input (e.g., a fingerprint).

In some examples, contract module 252 may be configured to cryptographically sign contract 220 using information already known by computing device 210 and the computing system that performs remote attestation of computing device 210, but is not known to other parties. Examples of such information may include a serial number or other information uniquely identifying computing device 210 that is not known to other parties. Computing device 210 may therefore send contract 220 to a computing system that performs remote attestation of computing device 210.

After contract module 252 sends contract 220 to a computing system that performs remote attestation of computing device 210, computing device 210 may attempt to prove that computing device 210 has the one or more properties specified by contract 220 in order for software application 254 to perform the associated action specified by contract 220. For example, computing device 210 may attempt to prove that computing device 210 has the one or more properties specified by contract 220 each time software application 254 is launched, in response to software application 254 invoking the associated action specified by contract 220, and the like. In some examples, computing device 210 may, while software application 254 executes at one or more processors 240, periodically attempt to prove that computing device 210 has the one or more properties specified by contract 220.

Proof module 216 may attempt to prove that computing device 210 has the one or more properties specified by contract 220 by formulating a zero-knowledge proof, such as a zk-SNARK proof, that computing device 210 has the one or more properties, and may send the zero-knowledge proof to the computing system that performs remote attestation of computing device 210. The zero-knowledge proof may prove that computing device 210 has the one or more properties specified by contract 220 without conveying any additional information regarding computing device 210. For example, to prove that the version of computing device 210's firmware is within a specified version range, the zero-knowledge proof may prove that the version of computing device 210's firmware is within a specified version range without conveying the actual version of computing device 210's firmware or any other additional information.

Proof module 216 may be configured to send an indication of the zero-knowledge proof to the computing system that performs remote attestation of computing device 210 by cryptographically signing contract 220 with the zero-knowledge proof and sending contract 220 signed with the zero-knowledge proof to the computing system that performs the remote attestation. If the computing system is able to successfully verify that the zero-knowledge proof proves that computing device 210 has the one or more properties specified by contract 220, the computing system may grant computing device 210 permission to perform the specified action.

In particular, computing device 210 may receive data that enables computing device 210 and/or software application 254 to perform the action specified by contract 220. For example, if the action specified by contract 220 is decryption and playback of an encrypted video stream, computing device 210 may receive an encryption key that enables software application 254 to decrypt and playback the encrypted video stream. In another example, if the action specified by contract 220 is authenticating software application 254 with an online banking system, computing device 210 may receive a security token that enables software application 254 to, using the security token, authenticate with the online banking system.

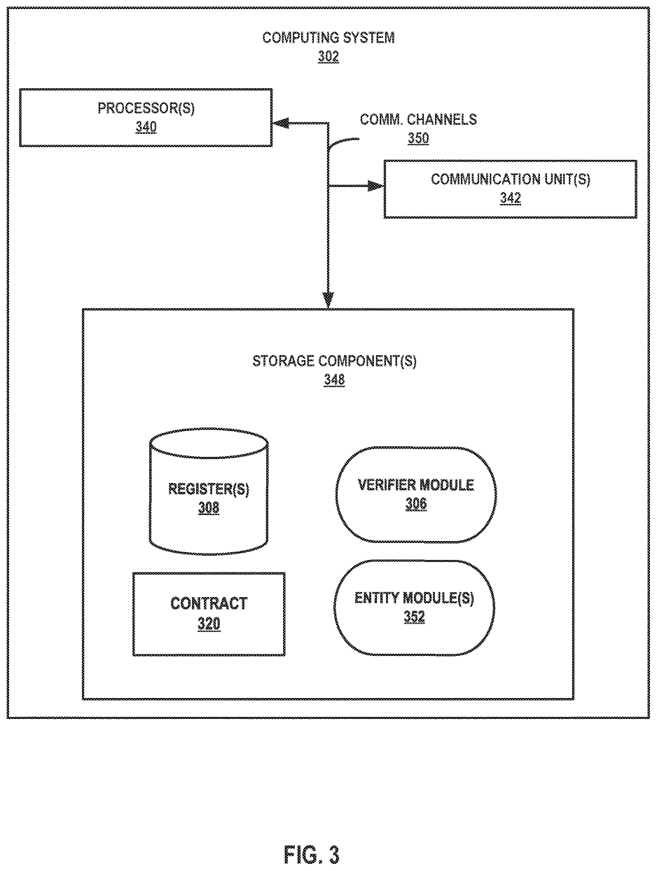

FIG. 3 is a block diagram illustrating further details of an example computing system, in accordance with one or more aspects of the present disclosure. Computing system 302 of FIG. 3 is described below as an example of computing system 102 of FIG. 1. FIG. 3 illustrates only one particular example of computing system 302, and many other examples of computing system 302 may be used in other instances and may include a subset of the components included in example computing system 302 or may include additional components not shown in FIG. 3. For example, computing system 302 may comprise a cluster of servers, and each of the servers comprising the cluster of servers making up computing system 302 may include all, or some, of the components described herein in FIG. 3, to perform the techniques disclosed herein.

As shown in the example of FIG. 3, computing system 302 includes one or more processors 340, one or more communication units 342, and one or more storage components 348. Storage components 348 include verifier module 306, one or more entity modules 352, and one or more registers 308. Verifier module 306 is an example of verifier module 106 shown in FIG. 1, and one or more registers 308 are an example of one or more registers 108 shown in FIG. 1.

One or more processors 340 may implement functionality and/or execute instructions associated with computing system 302. Examples of one or more processors 340 include application processors, display controllers, auxiliary processors, one or more sensor hubs, and any other hardware configured to function as a processor, a processing unit, or a processing device. Verifier module 306 and one or more entity modules 352 may be operable by one or more processors 340 to perform various actions, operations, or functions of computing system 302. For example, one or more processors 340 of computing system 302 may retrieve and execute instructions stored by one or more storage components 348 that cause one or more processors 340 to perform the operations of verifier module 306 and one or more entity modules 352. The instructions, when executed by one or more processors 340, may cause computing system 302 to store information within one or more storage components 348, for example, in one or more registers 308.

One or more communication units 342 of computing system 302 may communicate with external devices via one or more wired and/or wireless networks by transmitting and/or receiving network signals on the one or more networks. Examples of one or more communication units 342 include a network interface card (e.g., such as an Ethernet card), an optical transceiver, a radio frequency transceiver, a global positioning satellite (GPS) receiver, or any other type of device that can send and/or receive information. Other examples of one or more communication units 342 may include short wave radios, cellular data radios, wireless network radios, as well as universal serial bus (USB) controllers.

Communication channels 350 may interconnect each of the components 340, 342, and 348 for inter-component communications (physically, communicatively, and/or operatively). In some examples, communication channels 350 may include a system bus, a network connection, an inter-process communication data structure, or any other method for communicating data.

One or more storage components 348 within computing system 302 may store information for processing during operation of computing system 302 (e.g., computing system 302 may store data accessed by verifier module 306 and one or more entity modules 352 during execution at computing system 302). In some examples, one or more storage components 348 is a temporary memory, meaning that a primary purpose of one or more storage components 348 is not long-term storage. In this example, one or more storage components 348 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

In some examples, one or more storage components 348 may also include one or more computer-readable storage media. One or more storage components 348, in some examples, include one or more non-transitory computer-readable storage mediums. One or more storage components 348 may be configured to store larger amounts of information than typically stored by volatile memory. One or more storage components 348 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. One or more storage components 348 may store program instructions and/or information (e.g., data) associated with verifier module 306. One or more storage components 348 may include a memory configured to store data or other information associated with verifier module 306 and one or more registers 308.

Computing system 302 is configured to perform remote attestation of a computing devices (e.g., computing device 110 of FIG. 1) to determine whether the computing device has one or more properties specified by a contract. To perform remote attestation of a computing device, the computing device may generate an associated contract 320, which is an example of contract 120 of FIG. 1, which computing system 302 may use to perform remote attestation of the computing device and which also acts as a cryptographic key for secure communications between computing system 302 and the computing device.

To assist a computing device in generating contract 320, One or more entity modules 352 associated with and/or under the control of entities that relate to the computing device may be configured to generate one or more parameters. The one or more parameters may specify an action and an associated one or more properties, which may be used by the computing device to generate contract 320 that specifies the one or more properties that a computing device may be required to have in order to perform the action.

Each entity module of the one or more entity modules 352 may be associated with and/or under control of an entity that relates to the computing device for which computing system 302 performs remote attestation. Examples of the entities include a manufacturer of the computing device, a provider of the operating system of the computing device, a developer of a software application executing at the computing device, and the like.

Each entity module of the one or more entity modules 352 may specify, as one or more parameters, one or more properties of the computing device that can be verified by the respective entity module. For example, an entity module associated with and/or under the control of the provider of the operating system may specify, as one or more parameters, properties related to the operating system of the computing device. In another example, an entity module associated with and/or under the control of the manufacturer of the computing device may specify, as one or more parameters, properties related to the hardware and/or firmware of the computing device. Computing system 302 may therefore be configured to send the parameters generated by each of one or more entity modules 352 to the computing device for use in generating contract 320.

Computing system 302 may be configured to receive contract 320 from a computing device for which computing system 302 performs remote attestation and may be configured to, in response to receiving contract 320, verify contract 320 to determine whether contract 320 is a valid contract. For example, if contract 320 is cryptographically signed with secret information that may only be known to computing system 302 and the computing device that signed contract 320, verifier module 306 may be configured to verify the cryptographic signature of contract 320 and may, in response to successfully verifying the cryptographic signature, determine that contract 320 is a valid contract.

Verifier module 306 may be configured to, in response to determining that contract 320 is a valid contract, generate an attestation proof of the computing device and add the attestation proof to one or more registers 308. That is, computing system 302 may add an entry to each of one or more register 308 indicating that the computing device has the one or more properties specified by contract 320 and/or that contract 320 is a valid contract between the computing device and computing system 302.

In some examples, each register of one or more registers 308 is associated with and/or under the control of a respective entity module of one or more entity modules 352. For example, if one or more entity modules 352 includes two entity modules: an entity module associated with the manufacturer of the computing device and an entity module associated with the operating system provider of the computing device, each of the two entity modules may be associated with and/or control a respective register of one or more registers 308.

After receiving and validating contract 320, computing system 302 may be configured to receive a zero-knowledge proof that the computing device has the one or more properties specified by contract 320. For example, computing system 302 may be configured to receive contract 320 that is cryptographically signed with the zero-knowledge proof. Verifier module 306 may, in response to receiving contract 320 that is cryptographically signed with the zero-knowledge proof, validate contract 320 received from the computing device as a valid cryptographic key via any suitable technique of verifying cryptographic keys, such as by comparing the received contract 320 with contract 320 stored in one or more storage components 348.

If verifier module 306 successfully validates contract 320, verifier module 306 may be configured to verify that the zero-knowledge proof successfully proves that the computing device has the one or more properties specified by contract 320 to perform an associated action. For example, if it can be proven that the computing device has the one or more properties specified by contract 320 to perform an associated action if the zero-knowledge proof proves knowledge of a cryptographic sum of certain properties of the computing device, verifier module 306 may be configured to determine if the zero-knowledge proof actually proves such knowledge of a cryptographic sum of certain properties of the computing device.

In some examples, one or more entity modules 352 may be configured to verify whether the zero-knowledge proof proves that the computing device has the one or more properties specified by contract 320 to perform an associated action. As discussed above, each of one or more entity modules 352 may specify, as one or more parameters, one or more properties of the computing device that can be verified by the respective entity module. As such, each of one or more entity modules 352 may be configured to verify whether the zero-knowledge proof proves that the computing device has the one or more properties specified by the respective entity module. For example, if a first entity module of one or more entity modules 352 specifies a first one or more properties and if a second entity module of one or more entity modules 352 specifies a second one or more properties, the first entity module may be configured to verify whether the zero-knowledge proof proves that the computing device has the first one or more properties, and the second entity module may be configured to verify whether the zero-knowledge proof proves that the computing device has the second first one or more properties.

In some examples, if each of the one or more entity modules 352 successfully verifies that the zero-knowledge proof proves that the computing device has the respective one or more properties specified by the respective entity module within a specified time window, verifier module 306 may determine that the zero-knowledge proof proves that the computing device has each of the properties specified by contract 320. If verifier module 306 determines that the zero-knowledge proof does not prove that the computing device has the one or more properties specified by contract 320 to perform an associated action, verifier module 306 may be configured to invalidate contract 320. For example, verifier module 306 may be configured to update each of one or more registers 308 to indicate that contract 320 is not valid and that the computing device has not proved the computing device has each of the one or more properties specified by contract 320.

If verifier module 306 successfully verifies the zero-knowledge proof as proving that the computing device has each of the one or more properties specified by contract 320, computing system 302 may permit the computing device to perform the action associated with the one or more properties as specified by contract 320, such as by granting the computing device access to a resource used by the computing device to perform the action. For example, computing system 302 may grant computing device 110 access to an encryption key used to decrypt an encrypted video stream by sending the encryption key to the computing device.

In some examples, to grant the computing device access to a resource used by the computing device to perform the action specified by contract 320, one or more entity modules 352 may be configured to update one or more registers 308 to indicate that the computing device has been successfully validated as having the one or more properties specified by contract 320 to perform the action specified by contract 320. For example, if a first entity module specifies a first one or more properties specified in contract 320 and if a second entity module specifies a second one or more properties specified in contract 320, the first entity module may be configured to add an entry in a first register of one or more registers 308 to indicate that the computing device has the first one or more properties, and the second entity module may be configured to add an entry in a second register of one or more registers 308 to indicate that the computing device has the first one or more properties.

Computing system 302 as well as other third-party systems may use the information indicated in one or more registers 308 to determine whether to send one or more resources to the computing device to enable the computing device to perform the action specified by contract 320. For example, if the action specified by contract 320 is an action to play back an encrypted video stream, a system that stores an encryption key for decrypting the encrypted video stream may determine, based on the information in one or more registers 308, whether the computing device is permitted to play back the encrypted video stream. If the system determines, based on the information in one or more registers 308, that the computing device is permitted to play back the encrypted video stream, the system may send the encryption key for decrypting the encrypted video stream to the computing device.

In some examples, if verifier module 306 successfully verifies the zero-knowledge proof as proving that the computing device has each of the one or more properties specified by contract 320, computing system 302 may be configured to perform ratcheting, such as via use of a double ratcheting algorithm, of a cryptographic key used to securely communicate with the computing device, such as by performing ratcheting of contract 320. Computing system 302 may perform ratcheting of contract 320, so that even if contract 320 is compromised, the ratcheting of contract 320 may prevent malicious actors from using the stolen cryptographic key to compromise communications between computing system 302 and the computing device.

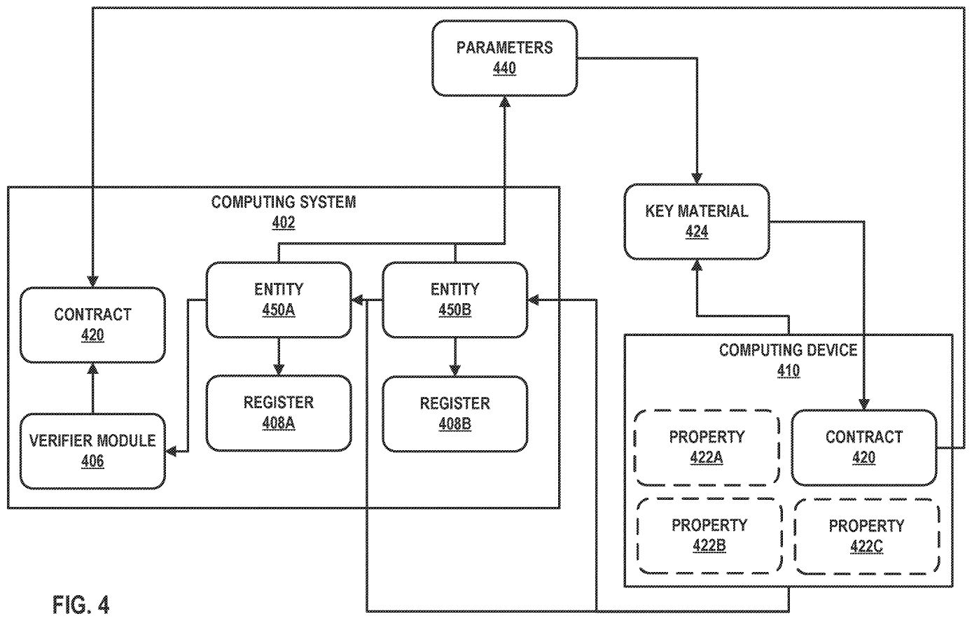

FIG. 4 illustrates an example technique for remote attestation, in accordance with aspects of this disclosure. As shown in FIG. 4, computing system 402, which is an example of computing system 102 of FIG. 1 and computing system 302 of FIG. 3, may perform remote attestation of computing device 410, which is an example of computing device 110 of FIG. 1 and computing device 210 of FIG. 2, to verify whether computing device 410 has one or more properties for the purposes of granting computing system 402 permission to perform one or more actions.

One or more entities may determine the actions that computing device 410 is allowed to perform based at least in part on verifying the state of computing device 410 and may agree on a set of parameters that indicate one or more actions and, for each of the one or more actions, an associated state of computing device 410 that, if verified, allows computing device 410 to perform the action. In the example of FIG. 4, the one or more entities may include two entities: entity 450A and entity 450B that may determine and generate parameters 440.

Entities 450A and 450B may be trusted parties such as the manufacturer of computing device 410, the provider of the operating system for computing device 410, an application developer, and/or other parties that may be trusted to determine the actions that computing device 410 is allowed to perform based at least in part on verifying the state of computing device 410. For example, entity 450A may be the provider of the operating system for computing device 410, and entity 450B may be the manufacturer of computing device 410.

Entities 450A and 450B may collude to determine parameters 440 that is used by computing device 410 to generate contract 420. Parameters may indicate one or more actions and, for each of the one or more actions, an associated one or more properties of computing device 410 that, if verified, allows computing device 410 to perform the action. For example, each of entities 450A and 450B may determine one or more properties of computing device 410 that may be required in order to allow computing device 410 to perform an action, the one or more properties of computing device 410 that can be verified by respective entities 450A and 450B, and the like, to determine and generate parameters 440.

In the example of FIG. 4, entities 450A and 450B may determine and generate parameters that indicate an action that can be performed by computing device 410 if computing device 410 has properties 422A, 422B, and 422C. Properties 422A, 422B, and 422C may include any combination of hardware properties, software properties, and the like.

Computing device 410 may use parameters 440 generated by entities 450A and 450B to generate cryptographic key material 424, and may generate contract 420, which is an example of contract 120 of FIG. 1, based at least in part on key material 424. For example, computing device 410 may generate contract 420 according to parameters 440 determined by entities 450A and 450B, which may indicate an action that computing device 410 is permitted to perform if computing device 410 has properties 422A, 422B, and 422C.

Contract 420 acts as a signature for one or more attestable states of computing device 410, such as the state of computing device 410's firmware, and is bound to unique information on computing device 410, which is referred to herein as an identity. The identity associated with computing device 410 is bound to computing device 110 by a witness. In the example where computing device 410 generates contract 420, the witness may be a form of authentication, such as a password entered by a user. As such, computing device 410 may generate contract 420 based at least in part on cryptographic key material 424 and a form of authentication, such as a password entered by the user.

Computing device 410 may also cryptographically sign contract 420 using information that is known to computing system 402 that performs remote attestation of computing device 410 and/or known to entities 450A and 450B. For example, such information may be information known at manufacturing time of computing device 410. Computing device 410 may therefore send the cryptographically signed contract 420 to computing system 402. Computing system 402 may, in response to receiving the cryptographically signed contract 420, verify the cryptographic signature of contract 420 and may, upon successful verification, store contract 420 and update registers 408A and 408B to add an attestation proof of computing device 410.

Multiple entities may each be associated with a respective register because different entities may prove different parts of a proof generated by computing device 410. In the example of FIG. 4, entity 450A may be a software entity, such as the provider of computing device 410's operating system, and may prove software properties of computing device 410. As such, entity 450A may be associated with register 408A that stores attestation proof of the software state of computing device 410. Similarly, entity 450B may be a hardware entity, such as the manufacturer of computing device 410, and may prove hardware properties of computing device 410. As such, entity 450B may be associated with register 408B that stores attestation proof of the hardware state of computing device 410. In the example of FIG. 4, computing system 402 may, upon successful verification of contract 420, add an attestation proof of computing device 410's software properties in register 408A, and add an attestation proof of computing device 410's hardware properties in register 408B.

Computing device 410 may generate a zero-knowledge proof, such as a zk-SNARK proof, that computing device 410 has one or more properties specified by contract 420 as being required to perform an action and may send an indication of the zero-knowledge proof to computing system 402. For example, computing device 410 may cryptographically sign contract 420 with the zero-knowledge proof and may send contract 420 that has been cryptographically signed using the zero-knowledge proof to computing system 402.

Computing system 402 may, in response to receiving the indication of the zero-knowledge proof, such as in the form of contract 420 cryptographically signed using the zero-knowledge proof, attempt to verify the zero-knowledge proof. That is, computing system 402 may determine whether the zero-knowledge proof successfully proves that computing device 110 has the one or more properties specified by contract 420 to perform an associated action.

In the example of FIG. 4, computing device 410 may generate a zero-knowledge proof that in its current state, computing device 410 has properties 422A-422C, where property 422A is a software property and properties 422B and 422C are hardware properties. As discussed above, multiple entities may each verify a portion of a proof received from computing device 410. That is, if a proof attempts to prove computing device 410 has multiple properties, each of the entities may verify a subset (i.e., fewer than all) of the multiple properties.

As such, in the example of FIG. 4, entity 450A as a software entity may verify the portion of the zero-knowledge proof proving that computing device 410 has software property 422A, and may add an entry in register 408A indicating whether entity 450A was able to successfully verify the portion of the zero-knowledge proof proving that computing device 410 has software property 422A. Similarly, entity 450B may verify the portion of the zero-knowledge proof proving that computing device 410 has hardware properties 422B and 422C, and may add an entry in register 408B indicating whether entity 450B was able to successfully verify the portion of the zero-knowledge proof proving that computing device 410B has hardware properties 422B and 422C.

Verifier module 406, which is an example of verifier module 106 of FIG. 1, may determine whether computing system 102 was able to successfully verify the zero-knowledge proof proving that computing device 110 has each of properties 422A-422C within a specified time window, which may be 5 seconds, 30 seconds, 1 minute, and the like. Limiting the amount of time for verifying the zero-knowledge proof may prevent limitless bounding and other ways for malicious actors to compromise the integrity of remote attestation. In some examples, verifier module 406 may also perform the proof verification described above as being performed by entities 450A and 450B.

If verifier module 406 determines that computing system 102 was able to successfully verify the zero-knowledge proof proving that computing device 110 has each of properties 422A-422C within a specified time window, verifier module 406 may determine that computing device 410 has successfully proved that computing device 410 has each of properties 422A-422C, and computing system 402 may grant computing device 410 permission to perform an action associated with properties 422A-422C. For example, because registers 408A and 408B include attestation proofs that computing device 410 has proven that computing device 410 has properties 422A-422C, a third-party (e.g., an external system) may, based on the attestation proofs in registers 408A and 408B, send a cryptographic key to computing device 410 that computing device 410 may use to perform the action associated with properties 422A-422C, such as to decrypt an encrypted video for playback and the like.

If verifier module 406 determines that computing device 410 has successfully proved that computing device 410 has each of properties 422A-422C, computing system 402 may perform ratcheting of contract 420, according to a cryptographic ratcheting algorithm, such as a double ratcheting algorithm. Performing ratcheting of contract 420 may enable computing system 402 and computing device 410 to ensure that even if contract 420 is stolen or otherwise known to a malicious actor, communications between computing system 402 and computing device 410 may remain secure.

If verifier module 406 determines that computing system 102 was not able to successfully verify the zero-knowledge proof proving that computing device 110 has each of properties 422A-422C within a specified time window, verifier module 406 may determine that computing device 410 has failed to prove that computing device 410 has each of properties 422A-422C. Computing device 410 may therefore invalidate contract 420, including updating registers 408A and 408B with information that indicates computing device 410 has failed to prove that computing device 410 has properties 422A-422C.

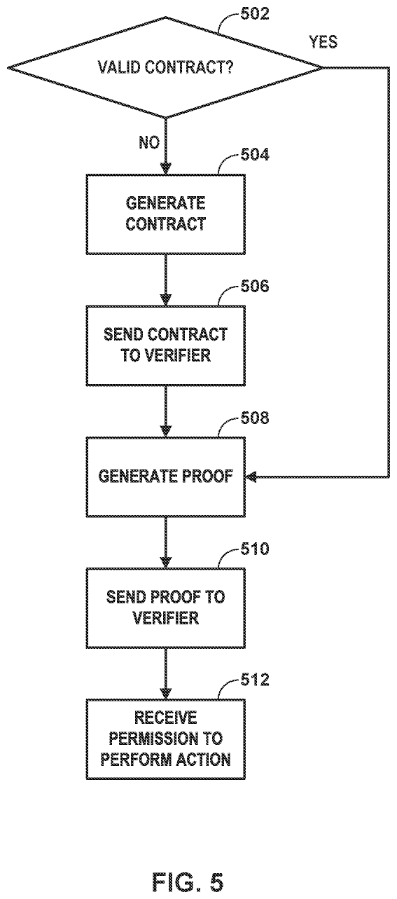

FIG. 5 is a flow chart of an example process for an example computing device to attest to having one or more properties, in accordance with aspects of this disclosure. In some examples, the process shown in FIG. 5 may be performed by computing device 110 shown in FIG. 1. In some implementations, the example process shown in FIG. 5 may include additional blocks, fewer blocks, different blocks, or differently arranged blocks than those depicted in FIG. 5. Additionally, or alternatively, two or more of the blocks of the example process may be performed in parallel.

As shown in FIG. 5, computing device 110 may, in order to prove that computing device 110 has one or more properties required to perform an action, determine whether a valid contract exists that specifies computing device 110 is allowed to perform the action if computing device 110 has the one or more properties (502). If computing device 110 determines that a valid contract does not exist (NO at step 502), computing device 110 may generate contract 120 that specifies computing device 110 is allowed to perform the action if computing device 110 has the one or more properties (504).

For example, computing device 110 may generate cryptographic key material based on parameters determined by one or more entities associated with computing device 110, and may generate contract 120 using the cryptographic key material. In some examples, computing device 110 may also receive an authentication factor, such as a password inputted by a user of computing device 110, and may generate contract 120 using the cryptographic key material and based on the inputted password.

Computing device 110 may send contract 120 to computing system 102 that performs remote attestation of computing device 110 (506). For example, computing device 110 may sign contract 120 with information that is known only to computing device 110 and computing system 102, and may send the signed contract 120 to computing system 102.

Computing device 110 may, subsequent to sending contract 120 to computing system 102, or in response to determining that a valid contract 120 exists (YES at step 502), generate a zero-knowledge proof that computing device 110 has the one or more properties required to perform the action (508) and send the zero-knowledge proof to computing system 102 (510). In some examples, the zero-knowledge proof may be a zk-SNARK proof or any other suitable zero-knowledge proof.

Computing device 110 may, in response to computing system 102 successfully verifying the zero-knowledge proof that computing device 110 has the one or more properties required to perform the action, receive permission to perform the action (512). For example, computing device 110 may receive, from computing system 102 or another remote computing system, data that enables computing device 110 to perform an action that requires the computing device 110 to have the one or more properties. Such data may be an encryption key that enables computing device 110 to decrypt certain encrypted content, a third-party resource, and the like.

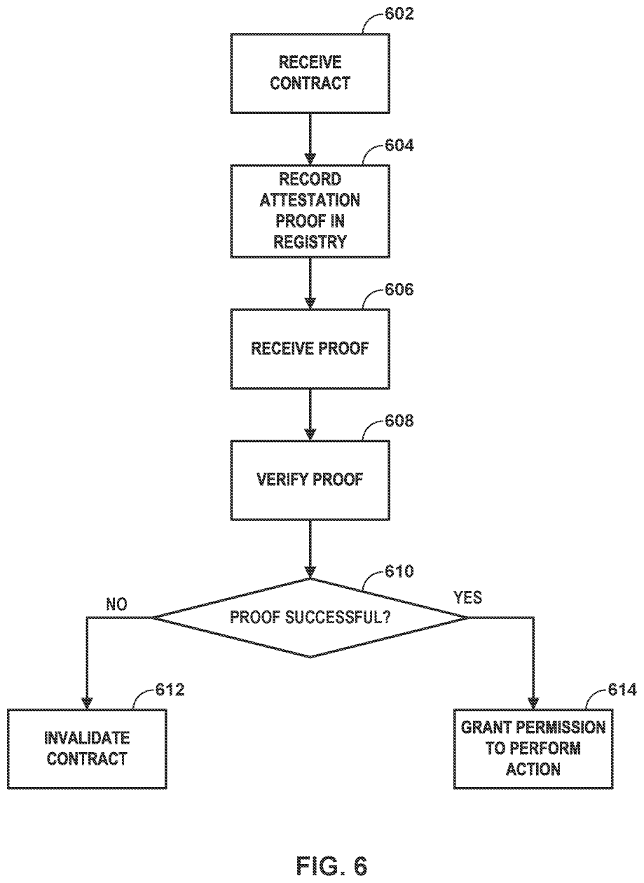

FIG. 6 is a flow chart of an example process for an example computing system to perform remote attestation of an example computing device, in accordance with aspects of this disclosure. In some examples, the process shown in FIG. 6 may be performed by computing system 102 shown in FIG. 1. In some implementations, the example process shown in FIG. 6 may include additional blocks, fewer blocks, different blocks, or differently arranged blocks than those depicted in FIG. 6. Additionally, or alternatively, two or more of the blocks of the example process may be performed in parallel.

As shown in FIG. 6, computing system 102 may receive, from computing device 110, contract 120 that specifies an action that requires computing device 110 to prove that computing device 110 has one or more properties. (602). Computing system 102 may verify contract 120, such as by determining whether contract 120 is signed using a valid signature, and may, upon successful verification of contract 120, record an attestation proof of computing device 110 in one or more registers 108 (604).

Subsequently, computing system 102 may receive, from computing device 110, an indication of a zero-knowledge proof that computing device 110 has the one or more properties specified in contract 120 (606). For example, computing system 102 may receive contract 120 that has been digitally signed using the zero-knowledge proof.

Computing system 102 may attempt to verify the zero-knowledge proof received from computing device 110 to determine whether the zero-knowledge proof successfully proves that computing device 110 has the one or more properties (608). If computing system 102 is unable to verify that the zero-knowledge proof proves that computing device 110 has the one or more properties (NO at 610), computing system 102 may invalidate contract 120 (612). For example,

[symbol]

If computing system 102 successfully verifies that the zero-knowledge proof proves that computing device 110 has the one or more properties (YES at 610), computing system 102 may grant permission for computing device 110 to perform the action specified in contract 120 that requires computing device 110 to prove that computing device 110 has the one or more properties (614). For example, computing system 102 may add an entry in one or more registers 108 indicating that computing device 110 has the one or more properties that are required to perform the action. Computing system 102 and other third-party computing systems may rely on the entry in one or more registers 108 to determine that computing device 110 has permission to perform the action. For example, an external system may, based on the entry in one or more registers 108 indicating that computing device 110 has the one or more properties that are required to perform the action, send, to computing device 110, an encryption key that computing device 110 may use to perform the action.

If computing system 102 successfully verifies that the zero-knowledge proof proves that computing device 110 has the one or more properties (YES at 608), computing system 102 may also perform ratcheting of contract 120. Each time computing device 110 successfully proves that computing device 110 has the one or more properties that are required to perform the action as specified by contract 120, computing device 110 may perform ratcheting of contract 120, which may help ensure secure communications between computing device 110 and computing system 102.

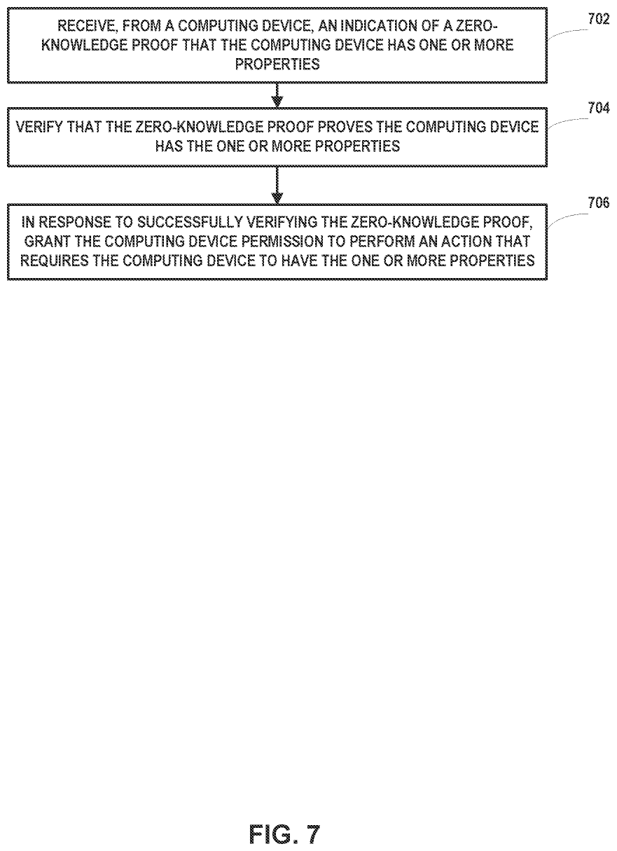

FIG. 7 is a flow chart of an example process for remote attestation, in accordance with aspects of this disclosure. FIG. 7 is described in the context of FIGS. 2 and 3. According to an example, one or more process blocks of FIG. 7 may be performed by computing system 302 shown in FIG. 3.

As shown in FIG. 7, the process may include one or more processors 340 of computing system 302 receiving, from a computing device 210, an indication of a zero-knowledge proof, such as a zero-knowledge succinct non-interactive argument of knowledge (zk-SNARK) proof, that the computing device 210 has one or more properties (block 702). For example, one or more processors 340 of computing system 302 may receive, from a computing device 210, an indication of a zero-knowledge proof that the computing device has one or more properties, as described above.

As in addition shown in FIG. 7, the process may include one or more processors 340 verifying that the zero-knowledge proof proves the computing device 210 has the one or more properties (block 704). For example, one or more processors 340 of computing system 302 may verify that the zero-knowledge proof proves the computing device 210 has the one or more properties.

As also shown in FIG. 7, the process may include one or more processors 340, in response to successfully verifying the zero-knowledge proof, granting the computing device 210 permission to perform an action that requires the computing device to have the one or more properties (block 706). For example, one or more processors 340 of computing system 302 may, in response to successfully verifying the zero-knowledge proof, grant the computing device 210 permission to perform an action, such as granting computing device 210 access to a resource, that requires the computing device 210 to have the one or more properties. In some examples, one or more processors 340 may grant computing device 210 permission to perform the action by sending, to the computing device 210, a cryptographic key that enables the computing device 210 to perform the action.

In some examples, a contract specifies, for each respective action of one or more actions, a respective one or more properties that the computing device 210 is required to have in order to perform the action. The contract may specify, for the action, that the computing device 210 is required to have the one or more properties in order to perform the action. In some examples, one or more processors 340 may, in response to the computing device 210 generating the contract, add an attestation proof of the computing device 210 to a register to indicate that the contract is valid.

In some examples, the contract specifies, for a second action, that the computing device 210 is required to have a second one or more properties in order to perform the second action. One or more processors 340 may receive, from computing device 210, an indication of a second zero-knowledge proof that the computing device 210 has the second one or more properties. One or more processors 340 may verify that the second zero-knowledge proof proves the computing device 210 has the second one or more properties. One or more processors 340 may, in response to not being able to successfully verify the second zero-knowledge proof, invalidate the contract.

In some examples, to receive, from computing device 210, the indication of the zero-knowledge proof that the computing device 210 has the one or more properties, one or more processors 340 may receive, from the computing device 210, the contract signed using the zero-knowledge proof. In some examples, one or more processors 340 may, in response to successfully verifying the zero-knowledge proof, perform ratcheting of the contract.

In some examples, one or more processors 340 may send, to the computing device 210, a plurality of parameters for generating the contract. In some examples, a first one or more parameters of the plurality of parameters are specified by a first entity, and a second one or more parameters of the plurality of parameters are specified by a second entity. In some examples, the first entity is a manufacturer of the computing device 210 and the second entity provides an operating system of the computing device 210.

In some examples, to verify that the zero-knowledge proof proves the computing device 210 has the one or more properties, one or more processors 340 may verify that the zero-knowledge proof proves the computing device 210 has a third one or more properties, verify that the zero-knowledge proof proves the computing device 210 has a fourth one or more properties, and, in response to successfully verifying that the zero-knowledge proof proves the computing device 210 has the third one or more properties and proves the computing device 210 has the fourth one or more properties within a specified time window, determine that the zero-knowledge proof has been successfully verified.

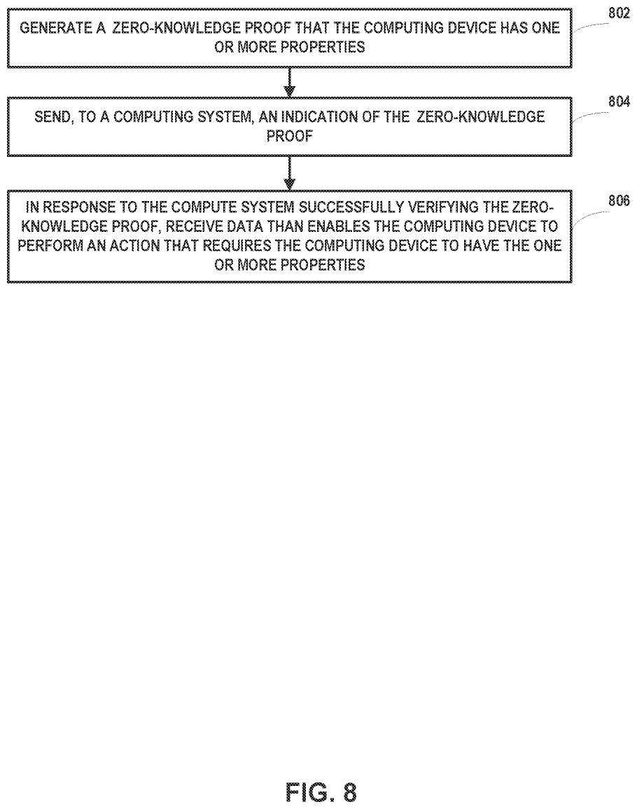

FIG. 8 is a flow chart of an example process for remote attestation, in accordance with aspects of this disclosure. FIG. 8 is described in the context of FIGS. 2 and 3. In some implementations, one or more process blocks of FIG. 8 may be performed by a computing device 210 shown in FIG. 2.

As shown in FIG. 8, the process may include generating a zero-knowledge proof that the computing device has one or more properties (block 802). For example, one or more processors 240 of computing device 210 may generate a zero-knowledge proof, such as a zero-knowledge succinct non-interactive argument of knowledge (zk-SNARK) proof, that the computing device 210 has one or more properties, as described above. As also shown in FIG. 8, the process may include sending, by the one or more processors to a computing system, an indication of the zero-knowledge proof (block 804). For example, one or more processors 240 of computing device 210 may send, to a computing system 302, an indication of the zero-knowledge proof, as described above. As further shown in FIG. 8, the process may include in response to the computing system 302 successfully verifying the zero-knowledge proof, receiving, by the one or more processors, data that enables the computing device to perform an action that requires the computing device to have the one or more properties (block 806). For example, one or more processors 240 of computing device 210 may, in response to the computing system 302 successfully verifying the zero-knowledge proof, receive data that enables the computing device 210 to perform an action that requires the computing device 210 to have the one or more properties, as described above, such as by receiving a cryptographic key that enables the computing device 210 to perform the action.

In some examples, a contract may specify, for each respective action of one or more actions, a respective one or more properties that the computing device 210 is required to have in order to perform the action, and may specify, for the action, that the computing device 210 is required to have the one or more properties in order to perform the action. One or more processors 240 of computing device 210 may receive a plurality of parameters for generating the contract and may generate the contract based at least in part on the parameters. In some examples, a first one or more parameters of the plurality of parameters are specified by a first entity, and a second one or more parameters of the plurality of parameters are specified by a second entity.

In some examples, to generate the contract based at least in part on the plurality of parameters, one or more processors 240 may generate cryptographic key material based at least in part on the plurality of parameters and may generate the contract using the cryptographic key material. In some examples, to generate the contract based at least in part on the plurality of parameters, one or more processors 240 may determine authentication information associated with the computing device 210 and may generate the contract based at least in part on the authentication information. Such authentication information may, in some examples, include a password.

In some examples, to send the indication of the zero-knowledge proof, one or more processors 240 may sign the contract with the zero-knowledge proof and may send, to the computing system 302, an indication of the signed contract. In some examples, computing device 210 may not provide a hardware assurance that the computing device 210 has the one or more properties.

Aspects of this disclosure include the following examples.

Example 1. A method comprising: receiving, by one or more processors of a computing system and from a computing device, an indication of a zero-knowledge proof that the computing device has one or more properties; verifying, by the one or more processors, that the zero-knowledge proof proves the computing device has the one or more properties; and in response to successfully verifying the zero-knowledge proof, granting, by the one or more processors, the computing device permission to perform an action that requires the computing device to have the one or more properties.

Example 2. The method of example 1, wherein the zero-knowledge proof is a zero-knowledge succinct non-interactive argument of knowledge (zk-SNARK) proof.

Example 3. The method of any of examples 1 and 2, wherein granting the computing device permission to perform the action further comprises: granting, by the one or more processors, the computing device access to a resource.

Example 4. The method of any of examples 1-3, wherein granting the computing device permission to perform the action further comprises: sending, by the one or more processors and to the computing device, a cryptographic key that enables the computing device to perform the action.

Example 5. The method of any of examples 1-4, wherein a contract specifies, for each respective action of one or more actions, a respective one or more properties that the computing device is required to have in order to perform the action.

Example 6, The method of example 5, wherein the contract specifies, for the action, that the computing device is required to have the one or more properties in order to perform the action.

Example 7. The method of any of examples 5 and 6, further comprising: in response to the computing device generating the contract, adding, by the one or more processors, an attestation proof of the computing device to a register to indicate that the contract is valid.

Example 8. The method of any of examples 5-7, wherein the contract specifies, for a second action, that the computing device is required to have a second one or more properties in order to perform the second action, further comprising: receiving, by the one or more processors and from a computing device, an indication of a second zero-knowledge proof that the computing device has the second one or more properties; verifying, by the one or more processors, that the second zero-knowledge proof proves the computing device has the second one or more properties; and in response to not being able to successfully verify the second zero-knowledge proof, invalidating, by the one or more processors, the contract.

Example 9. The method of any of example 5-8, wherein receiving, from a computing device, the indication of the zero-knowledge proof that the computing device has the one or more properties further comprises: receiving, by the one or more processors and from the computing device, the contract signed using the zero-knowledge proof.

Example 10. The method of any of example 5-8, further comprising: in response to successfully verifying the zero-knowledge proof, performing, by the one or more processors, ratcheting of the contract.

Example 11. The method of any of examples 5-9, further comprising: sending, by the one or more processors and to the computing device, a plurality of parameters for generating the contract.

Example 12. The method of example 11, wherein: a first one or more parameters of the plurality of parameters are specified by a first entity, and a second one or more parameters of the plurality of parameters are specified by a second entity.

Example 13. The method of example 12, wherein the first entity is a manufacturer of the computing device and the second entity provides an operating system of the computing device.

Example 14. The method of any of examples 12 and 13, wherein verifying that the zero-knowledge proof proves the computing device has the one or more properties further comprises: verifying, by the one or more processors, that the zero-knowledge proof proves the computing device has a third one or more properties; verifying, by the one or more processors, that the zero-knowledge proof proves the computing device has a fourth one or more properties; and in response to successfully verifying that the zero-knowledge proof proves the computing device has the third one or more properties and proves the computing device has the fourth one or more properties within a specified time window, determining, by the one or more processors, that the zero-knowledge proof has been successfully verified.

Example 15. A computing system comprising: a memory that stores instructions; and one or more processors that execute the instructions to perform the method of any of examples 1-14.

Example 16. An apparatus comprising: means for performing the method of any of examples 1-14.

Example 17. A non-transitory computer-readable storage medium comprising instructions, that when executed by one or more processors of a computing system, cause the one or more processors to perform the method of any of examples 1-14.

Example 18. A method comprising: generating, by one or more processors of a computing device, a zero-knowledge proof that the computing device has one or more properties; sending, by the one or more processors to a computing system, an indication of the zero-knowledge proof, and in response to the computing system successfully verifying the zero-knowledge proof, receiving, by the one or more processors, data that enables the computing device to perform an action that requires the computing device to have the one or more properties.

Example 19. The method of example 18, wherein the zero-knowledge proof is a zero-knowledge succinct non-interactive argument of knowledge (zk-SNARK) proof.

Example 20. The method of any of examples 18 and 19, wherein receiving the data that enables the computing device to perform an action that requires the computing device to have the one or more properties further comprises: receiving, by the one or more processors, a cryptographic key that enables the computing device to perform the action.

Example 21. The method of any of examples 18-20, wherein a contract specifies, for each respective action of one or more actions, a respective one or more properties that the computing device is required to have in order to perform the action.

Example 22. The method of example 21, wherein the contract specifies, for the action, that the computing device is required to have the one or more properties in order to perform the action.

Example 23. The method of any of examples 21 and 22, further comprising: receiving, by the one or more processors, a plurality of parameters for generating the contract; and generating, by the one or more processors, the contract based at least in part on the parameters.

Example 24. The method of example 23, wherein: a first one or more parameters of the plurality of parameters are specified by a first entity, and a second one or more parameters of the plurality of parameters are specified by a second entity.

Example 25. The method of any of examples 23 and 24, wherein generating the contract based at least in part on the plurality of parameters further comprises: generating, by the one or more processors, cryptographic key material based at least in part on the plurality of parameters; and generating, by the one or more processors, the contract using the cryptographic key material.

Example 26. The method of any of examples 23-25, wherein generating the contract based at least in part on the plurality of parameters further comprises: determining, by the one or more processors, authentication information associated with the computing device; and generating, by the one or more processors, the contract based at least in part on the authentication information.

Example 27. The method of example 26, wherein the authentication information comprises a password.

Example 28. The method of any of examples 21-27, wherein sending the indication of the zero-knowledge proof further comprises: signing, by the one or more processors, the contract with the zero-knowledge proof; and sending, by the one or more processors to the computing system, an indication of the signed contract.

Example 29. The method of any of examples 21-28, wherein the computing device does not provide a hardware assurance that the computing device has the one or more properties.

Example 30. A computing device comprising: a memory that stores instructions; and one or more processors that execute the instructions to perform the method of any of examples 18-29.

Example 31. An apparatus comprising: means for performing the method of any of examples 18-29.

Example 32. A non-transitory computer-readable storage medium comprising instructions, that when executed by one or more processors of a computing device, cause the one or more processors to perform the method of any of examples 18-29.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of a computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structures suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

Various embodiments have been described. These and other embodiments are within the scope of the following claims.

1. A method comprising:
generating, by one or more processors of a computing device, a zero-knowledge proof that the computing device has one or more properties;
sending, by the one or more processors, to a computing system, an indication of the zero-knowledge proof; and
in response to the computing system successfully verifying the zero-knowledge proof, receiving, by the one or more processors, data that enables the computing device to perform an action that requires the computing device to have the one or more properties.

2. The method of claim 1, wherein the zero-knowledge proof is a zero-knowledge succinct non-interactive argument of knowledge (zk-SNARK) proof.

3. The method of claim 1, wherein receiving the data that enables the computing device to perform an action that requires the computing device to have the one or more properties further comprises:
receiving, by the one or more processors, a cryptographic key that enables the computing device to perform the action.

4. The method of claim 1, wherein a contract specifies, for each respective action of one or more actions, a respective one or more properties that the computing device is required to have in order to perform the action, and wherein sending the indication of the zero-knowledge proof further comprises:
signing, by the one or more processors, the contract with the zero-knowledge proof, and
sending, by the one or more processors to the computing system, an indication of the signed contract.

5. The method of claim 4, further comprising:
receiving, by the one or more processors, a plurality of parameters for generating the contract; and
generating, by the one or more processors, the contract based at least in part on the plurality of parameters.

6. The method of claim 5, wherein: a first one or more parameters of the plurality of parameters are specified by a first entity, and a second one or more parameters of the plurality of parameters are specified by a second entity.

7. The method of claim 5, wherein generating the contract based at least in part on the plurality of parameters further comprises:
generating, by the one or more processors, cryptographic key material based at least in part on the plurality of parameters; and
generating, by the one or more processors, the contract using the cryptographic key material.

8. The method of claim 5, wherein generating the contract based at least in part on the plurality of parameters further comprises:
determining, by the one or more processors, authentication information associated with the computing device; and
generating, by the one or more processors, the contract based at least in part on the authentication information.

9. The method of claim 8, wherein the authentication information comprises a password.

10. The method of any of claims 1-9, wherein the computing device does not provide a hardware assurance that the computing device has the one or more properties.

11. A computing device comprising:
a memory that stores instructions; and
one or more processors that execute the instructions to:
generate a zero-knowledge proof that the computing device has one or more properties;
send, to a computing system, an indication of the zero-knowledge proof; and
in response to the computing system successfully verifying the zero-knowledge proof, receive data that enables the computing device to perform an action that requires the computing device to have the one or more properties.

12. The computing device of claim 11, wherein the zero-knowledge proof is a zero-knowledge succinct non-interactive argument of knowledge (zk-SNARK) proof.

13. The computing device of claim 11, wherein to receive the data that enables the computing device to perform an action that requires the computing device to have the one or more properties, the one or more processors further execute the instructions to:
receive a cryptographic key that enables the computing device to perform the action.

14. The computing device of claim 11, wherein a contract specifies, for each respective action of one or more actions, a respective one or more properties that the computing device is required to have in order to perform the action, and wherein to send the indication of the zero-knowledge proof, the one or more processors further execute the instructions to:
sign the contract with the zero-knowledge proof; and
send, to the computing system, an indication of the signed contract.

15. The computing device of claim 14, wherein the one or more processors further execute the instructions to:
receive a plurality of parameters for generating the contract; and
generate the contract based at least in part on the plurality of parameters.

16. The computing device of claim 15, wherein: a first one or more parameters of the plurality of parameters are specified by a first entity, and a second one or more parameters of the plurality of parameters are specified by a second entity.

17. The computing device of claim 15, wherein generating the contract based at least in part on the plurality of parameters further comprises:
generating, by the one or more processors, cryptographic key material based at least in part on the plurality of parameters; and
generating, by the one or more processors, the contract using the cryptographic key material.

18. The computing device of claim 15, wherein to generate the contract based at least in part on the plurality of parameters, the one or more processors further execute the instructions to:
determine authentication information associated with the computing device; and
generate the contract based at least in part on the authentication information.

19. The computing device of claim 18, wherein the authentication information comprises a password.

20. A non-transitory computer-readable storage medium comprising instructions, that when executed by one or more processors of a computing device, cause the one or more processors to:
generate a zero-knowledge proof that the computing device has one or more properties;
send, to a computing system, an indication of the zero-knowledge proof; and
in response to the computing system successfully verifying the zero-knowledge proof, receive data that enables the computing device to perform an action that requires the computing device to have the one or more properties.

21. (canceled)
